(19) United States
(12) Patent Application Publication
(10) Pub. No.: US 2017/0126423 A1
(43) Pub. Date: May 4, 2017

(54) METHOD, APPARATUS AND SYSTEM FOR SETTING OPERATING MODE OF DEVICE

(71) Applicant: Xiaomi Inc., Beijing (CN)

(72) Inventors: Weiguang JIA, Beijing (CN); Tian REN, Beijing (CN); Enxing HOU, Beijing (CN)

(73) Assignee: Xiaomi Inc., Beijing (CN)

(21) Appl. No.: 15/073,110

(22) Filed: Mar. 17, 2016

(30) Foreign Application Priority Data
Oct. 29, 2015 (CN) 201510719239.9

(51) Int. Cl. H04L 12/28; H04L 12/24

(52) U.S. Cl. CPC H04L 12/2818; H04L 12/2807; H04L 41/22; H04L 41/0873; H04L 2012/2841

(57) ABSTRACT

Aspects of the disclosure provide a method that includes: detecting an operating mode of a first device; and causing a second device associated with the first device to set an operating mode of the second device to a target operating mode, where the target operating mode matches the detected operating mode of the first device. Aspects of the disclosure also provide an apparatus that includes a processor configured to detect an operating mode of a first device, and to cause a second device associated with the first device to set an operating mode of the second device to a target operating mode, where the target operating mode matches the detected operating mode of the first device.

### CROSS-REFERENCE TO RELATED APPLICATION

This application claims priority to Chinese Patent Application No. 201510719239.9, filed Oct. 29, 2015, which is incorporated herein by reference in its entirety.

### FIELD

The present disclosure generally relates to communication technology, and more particularly to method, apparatus, and system for setting an operating mode of a device.

### BACKGROUND

A smart home application program is a client software program for operating, such as accessing, tying, or controlling, a smart device through a server. A user may execute the smart home application program on a smart device, log in a server using a user account via the smart home application program, and associate the smart device, such as a smart socket, a smart air purifier, a smart light bulb, etc., with the server under the user account. The user may also tie the smart device with the user account such that the smart device can only receive the control instructions from a mobile terminal or another smart device that also executes the smart home application program under the same user account.

### SUMMARY

Aspects of the disclosure provide a method that includes: detecting an operating mode of a first device; and causing a second device associated with the first device to set an operating mode of the second device to a target operating mode, where the target operating mode matches the detected operating mode of the first device.

In an embodiment, causing the second device to set the operating mode of the second device to the target operating mode includes: sending association information to the first device, wherein the association information comprises information regarding one or more devices, including the second device, that are associated with the first device; receiving a selection instruction from the first device, the selection instruction indicating that one or more selected devices, including the second device, among the one or more devices that are associated with the first device are selected; and causing each device of the one or more selected devices indicated in the selection instruction, including the second device, to set an operating mode thereof to a corresponding target operating mode.

In an embodiment, causing the second device associated with the first device to set the operating mode of the second device to the target operating mode includes, in response to a result that the detected operating mode of the first device is a silent mode of the first device, causing the second device to set the operating mode of the second device to a silent mode of the second device.

In an embodiment, detecting the operating mode of the first device includes: receiving a notification from the first device indicating that the operating mode of the first device is the silent mode of the first device; and, in response to the received notification from the first device, determining that the detected operating mode of the first device is the silent mode of the first device.

Aspects of the disclosure also provide an apparatus that includes a processor configured to detect an operating mode of a first device, and to cause a second device associated with the first device to set an operating mode of the second device to a target operating mode, where the target operating mode matches the detected operating mode of the first device.

In an embodiment, the processor, when executing the processor-executable instructions, is configured to send association information to the first device, wherein the association information comprises information regarding one or more devices, including the second device, that are associated with the first device, receive a selection instruction from the first device, the selection instruction indicating that one or more selected devices, including the second device, among the one or more devices that are associated with the first device are selected, and causing each device of the one or more selected devices indicated in the selection instruction, including the second device, to set an operating mode thereof to a corresponding target operating mode.

In an embodiment, the processor, when causing the second device associated with the first device to set the operating mode of the second device to the target operating mode, is configured to, in response to a result that the detected operating mode of the first device is a silent mode of the first device, cause the second device to set the operating mode of the second device to a silent mode of the second device.

Aspects of the disclosure also provide a system that includes a first device, a second device, and a server. In one embodiment, the server is configured to detect an operating mode of the first device, and to cause the second device associated with the first device to set an operating mode of the second device to a target operating mode, wherein the target operating mode matches the detected operating mode of the first device.

In one embodiment, the first device is configured to detect a current operating mode of the first device, send a notification to the server, wherein the notification indicates the current operating mode of the first device, output association information received from the server and acquired according to the notification for display, wherein the association information comprises the information regarding one or more devices, including the second device, that are associated with the first device, detect a selection operation for selecting one or more associated devices according to the association information, and send a selection instruction to the server, wherein the selection instruction is used to instruct the server to control one or more selected devices indicated in the selection instruction to set respective operating modes to corresponding target operating modes.

### BRIEF DESCRIPTION OF THE DRAWINGS

The accompanying drawings, which are incorporated in and constitute a part of this disclosure, illustrate embodiments in accordance with the disclosure and, together with the description, serve to explain the principles of the disclosure.

FIG. 1 is a flow chart of an example method for setting an operating mode of a device according to an embodiment of the disclosure.

FIG. 2 is a flow chart of an example method for setting an operating mode of a device according to an embodiment of the disclosure.

FIG. 3 is a flow chart of an example method for setting an operating mode of a device according to an embodiment of the disclosure.

FIG. 4 is a flow chart of an example method for setting an operating mode of a device according to an embodiment of the disclosure.

FIG. 5 is a flow chart of an example method for setting an operating mode of a device according to an embodiment of the disclosure.

FIG. 6 is a block diagram of an example apparatus for setting an operating mode of a device according to an embodiment of the disclosure.

FIG. 7 is a block diagram of an example apparatus for setting an operating mode of a device according to an embodiment of the disclosure.

FIG. 8 is a block diagram of an example apparatus for setting an operating mode of a device according to an embodiment of the disclosure.

FIG. 9 is a block diagram of an example apparatus for setting an operating mode of a device according to an embodiment of the disclosure.

FIG. 10 is a block diagram of an example apparatus for setting an operating mode of a device according to an embodiment of the disclosure.

FIG. 11 is a block diagram of an example apparatus for setting an operating mode of a device according to an embodiment of the disclosure.

FIG. 12 is a block diagram of an example apparatus for setting an operating mode of a device according to an embodiment of the disclosure.

FIG. 13 is a block diagram of an example first device for setting an operating mode of a second device according to an embodiment of the disclosure.

FIG. 14 is a block diagram of an example first device according to an embodiment of the disclosure.

FIG. 15 is a block diagram of an example server according to an embodiment of the disclosure.

FIG. 16 is a block diagram of an example system for setting an operating mode of a device according to an embodiment of the disclosure.

### DETAILED DESCRIPTION

Reference will now be made in detail to various embodiments, examples of which are illustrated in the accompanying drawings. The following description refers to the accompanying drawings in which same numbers in different drawings represent same or similar elements unless otherwise described. The implementations set forth in the following description of various embodiments do not represent all implementations consistent with the disclosure. Instead, they are merely examples of device and methods consistent with various features disclosed in the present disclosure.

Embodiments of the disclosure may provide at least some of the following beneficial effects: by detecting an operating mode of a first device, a server controls a second device associated with the first device to set an operating mode of the second device to a target operating mode, wherein the target operating mode matches the operating mode of the first device. In some embodiments, a user only needs to set operating state of a first device, and the server may automatically control a second device associated with the first device to set the operating mode thereof to a target operating mode according to the operating mode of the first device. In accordance with some embodiments of the present disclosure, a user may conveniently and efficiently set operating modes of associated devices.

It is to be understood that both the forgoing general description and the following detailed description are exemplary only, and are not restrictive of the present disclosure.

FIG. 1 is a flow chart of an example method for setting an operating mode of a device according to an embodiment of the disclosure. As shown in FIG. 1, the method for setting an operating mode of a device can be performed by a server, wherein the method includes the following steps.

In step S101, an operating mode of a first device is detected. In some embodiments, the operating mode of the first device includes a silent mode, a vibration mode, a sound mode, etc., of the first device.

The server may initiate detecting a current operating mode of a first device. For example, the server may send a request to the first device, where the request corresponds to causing the first device to report a current operating mode of the first device. After receiving the request sent by the server, the first device sends a notification to the server, where the notification indicates the current operating mode of the first device. In some embodiments, the server sends requests for reporting operating modes to the first device based on a predetermined polling period.

Additionally or alternatively, the first device may cause the server to perform the detection step S101 by reporting the current operating mode of the first device without any request from the server. For example, if the operating mode of the first device changes, the first device reports to the server by sending a notification that indicates the current operating mode of the first device after the change of the operating mode of the first device.

In step S102, a second device associated with the first device is caused to set an operating mode of the second device to a target operating mode, where the target operating mode matches the detected operating mode of the first device.

The first device may be a mobile terminal, such as a smart phone, a tablet, or the like. The second device may be a smart home device, such as a smart socket, a smart air purifier, a smart light bulb, a smart refrigerator, etc. The second device may communicate with the server via a client program installed thereon. For example, Xiaomi smart home application program is a client software program for operating, such as accessing, tying, or controlling, a smart device through a server. A user may associate the smart devices executing the Xiaomi smart home application program with the server. In addition to controlling the smart devices individually by using the application program, the user may also set a smart scene mode via the application program to associate a plurality of smart devices and to control the associated smart devices in a coherent manner in response to various triggering conditions. In some embodiments, the method as illustrated in FIG. 1 is usable to control a plurality of smart devices associated with a mobile terminal under a smart scene mode.

In at least one embodiment, after detecting the operating mode of the first device, the server controls the second device associated with the first device to cause the second device to set the operating mode thereof to a target operating mode. The association between the first device and the second device may be previously stored in the server, or may be obtained by the server from the first device when needed.

In some embodiments, the target operating mode of a device matches the detected operating mode of another device when the target operating mode is consistent with the detected operating mode and thus corresponding to consistent user experiences. For example, the target operating mode matching the detected operating mode of the first device includes: the target operating mode and the detected operating mode of the first device are set to silent modes of the respective devices; or the target operating mode and the detected operating mode of the first device are set to sound modes of the respective devices. In some embodiments, the target operating mode of a device matches the detected operating mode of another device when the target operating mode and the detected operating mode corresponding to the same predetermined scenery stored in the server. For example, if the detected operating mode of the first device is a silent mode, the target operating mode of the second device can be a vibration mode or a low-volume mode, where the low-volume mode refers to that the volume of the second device is set to be audible only to the audience nearby the second device. In some embodiments, after the user manually set the operating mode of the first device, the server may automatically cause the second device and/or other smart devices associated with the first device to set respective operating modes thereof to corresponding target operating modes. As such, the user may avoid manually setting the operating modes for all the associated smart devices manually one at a time. In accordance with some embodiments of the present disclosure, a user may conveniently set operating modes of a plurality of devices, and the user experience with respect to operating smart devices is thus improved.

In an example application, when a user is resting or working, the user may want to set the associated smart devices, such as a cell phone, smart sockets, air purifiers, light bulbs, or refrigerators, to corresponding silent modes thereof to avoid being disturbed by the associated smart devices. In accordance with some embodiments of the disclosure, the user may set the operating mode of the cell phone to a silent mode. After detecting that the operating mode of the cell phone is switched to the silent mode, the server causes the smart sockets, air purifiers, light bulbs, or refrigerators associated with the cell phone to set the operating modes thereof to corresponding silent modes.

In some embodiments, by detecting the operating mode of the first device, the server causes the second device associated with the first device to set an operating mode of the second device to a target operating mode, wherein the target operating mode matches the detected operating mode of the first device. In some embodiments, a user only needs to set the operating mode of a first device, and the server may automatically control a second device associated with the first device to set an operating mode of the second device to a target operating mode according to the detected operating mode of the first device. Therefore, an operating mode of a device may be set more conveniently and efficiently.

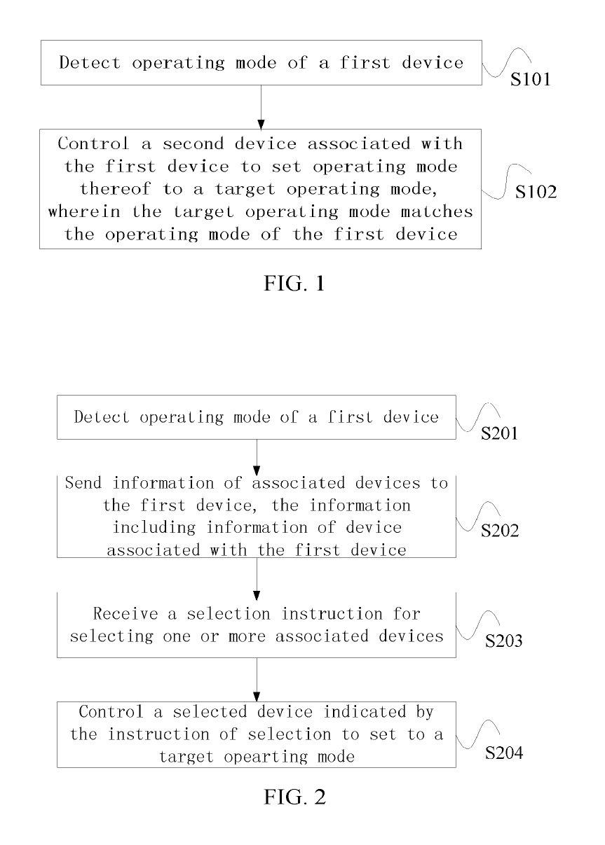

FIG. 2 is a flow chart of an example method for setting an operating mode of a device according to an embodiment of the disclosure. On the basis of the embodiment as shown in FIG. 1, the embodiment depicted in FIG. 2 further describes how to control a device to set its operating mode to a target operating mode. As shown in FIG. 2, the method for setting an operating mode of a device includes the following steps.

In step S201, an operating mode of the first device is detected.

In step S202, information of associated device is set to the first device. The information of associated device includes information regarding one or more devices associated with the first device.

In some embodiments, the association information regarding associated devices may include information regarding one or more devices which are associated with the first device. In some embodiments, the association information may include information regarding one or more devices that are associated with the first device and the current operating modes thereof do not match the detected operating mode of the first device. The information of the one or more devices associated with the first device may be previously stored in the server. In at least one embodiment, the server can not only detect the operating mode of the first device, but also can detect the operating modes of the devices associated with the first device. As such, the server may determine whether the operating modes of various associated devices match that of the first device. The server may send the association information including the information of the devices that are associated with the first device and that the operating modes thereof do not match the detected operating mode of the first device. In some embodiments, the server may send the association information including the information of the associated devices and the respective operating modes thereof detected by the server.

In step S203, a selection instruction from the first device is received. The selection instruction indicates that one or more selected devices, including for example a second device, among the one or more devices that are associated with the first device are selected.

For example, after receiving the association information sent by the server, the first device selects the devices from the devices associated with the first device such that the operating modes of the selected devices will be set to corresponding target operating modes. In an alternative embodiment, the first device displays the information of associated devices sent by the server as a list on a display of the first device, and a user selects the devices that will be set to corresponding target operating modes according to the user's preference. The user may select only some or all of the devices associated with the first device that will be set to corresponding target operating modes. The first device generates a selection instruction based on a user operation and sends the selection instruction to the server in order to configure the operating modes of the selected devices.

In step S204, a selected device, such as the second device, indicated in the selection instruction is caused to set the operating mode to a target operating mode.

In some embodiments, after receiving the selection instruction, the server controls the second device indicated in the selection instruction to set the operating mode of the second device to a target operating mode. The server may send an instruction for configuring the operating mode to the second device, and the instruction for configuring the operating mode including information regarding the target operating mode. After receiving the instruction for configuring the operating mode, the second device set the operating mode to the target operating mode included in the instruction for configuring the operating mode.

For example, after detecting that a current operating mode of a cell phone is a silent mode of the first device, the server sends the information of associated device with respect to smart devices, such as smart sockets, smart air purifiers, smart light bulbs, smart refrigerators, or the like, that are associated with the cell phone to the cell phone. The user may choose which device among the associated devices subject to operating mode configuration by operating the cell phone. The cell phone generates and sends a selection instruction to the server. According to the selection instruction, the server controls the associated devices indicated in the selection instruction to set the respective operating modes to the corresponding silent modes. If the user only selects to configure the operating modes of the a smart socket and a smart air purifier, the server can only set the operating modes of the selected smart socket and the selected smart air purifier to the corresponding silent modes.

In some embodiments, the server detects the operating mode of the first device, and sends the association information regarding associated devices to the first device, wherein the association information includes the device information regarding one or more devices associated with the first device. The server receives the selection instruction from the first device, and controls the one or more selected devices indicated in the selection instruction to set the operating modes thereof to the corresponding target operating modes. In at least one embodiment, by sending the association information to the first device by the server, a user may select the associated devices that are subject to configuring the operating modes thereof according to the user's preferences. In accordance with some embodiments of the present disclosure, a user may conveniently set operating modes of selected devices, and the user experience with respect to operating smart devices is thus improved.

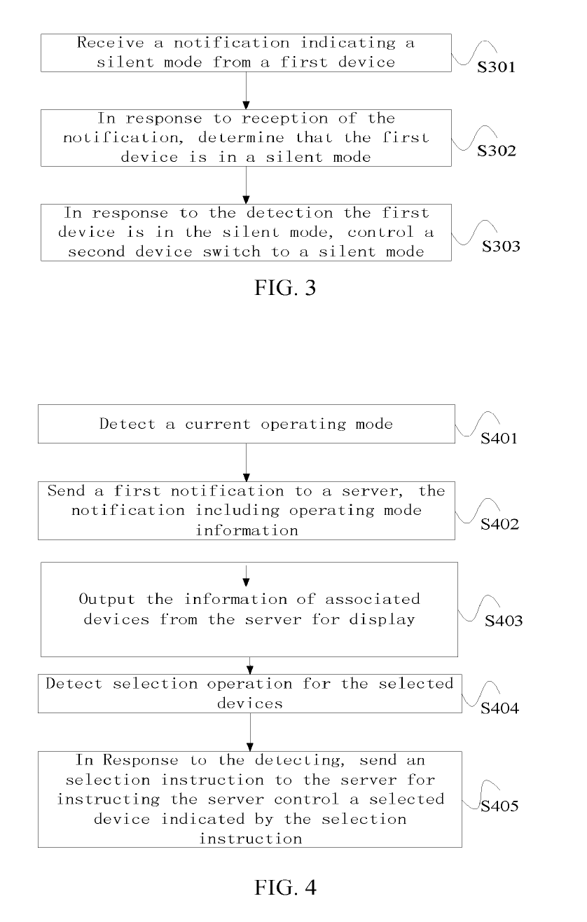

FIG. 3 is a flow chart of an example method for setting an operating mode of a device according to an embodiment of the disclosure. On the basis of the embodiment as shown in FIG. 1, the embodiment depicted in FIG. 3 describes how to control a device to set the operating mode thereof to a silent mode. As shown in FIG. 3, the method for setting an operating mode of a device includes the following steps.

In step S301, a notification from a first device is received. The notification indicates that a current operating mode of the first device is set to a silent mode.

In some embodiments, after being set to a silent mode, the first device sends the notification to the server to inform the server that the current operating mode of the first device is a silent mode. The sending of the notification may be initiated by the first device without any inquiry or instruction from the server.

In step S302, the operating mode of the first device is determined to be the silent mode of the first device in response to the reception the notification.

After receiving the notification of the operating mode of the first device, the server determines that the first device is in the silent mode of the first device.

In step S303, a second device is caused to set an operating mode thereof to a silent mode of the second device in response to the determination that the first device is in the silent mode of the first device.

In at least one embodiment, causing the second device to set its operating mode to the silent mode of the second device may be performed according to Steps S202-204 illustrated in FIG. 2, and detailed description thereof is thus omitted. In an alternative embodiment, after determining that the first device is in the silent mode, the server causes all the devices associated with the first device to set the respective operating modes consistent with the detected operating mode of the first device without any further user instruction. In some embodiments, the server is able to control the activation or deactivation of the silent mode of the second device consistent with the activation or deactivation of the silent mode of the first device.

In some embodiments, by receiving a notification from the first device indicating an operating mode of the first device, the server determines that the first device is in the reported operating mode, such as a silent mode of the first device, in response to the notification. The server controls the second device associated with the first device to set an operating mode of the second device to an operating mode, such as a silent mode of the second device, consistent with the operating mode of the first device. In at least one embodiment, the user only needs to set the operating mode of the first device to a silent mode, and the server will automatically control the second device associated with the first device to set an operating mode to a silent mode of the second device according to the operating mode of the first device. In accordance with some embodiments of the present disclosure, a user may conveniently set operating modes of associated devices.

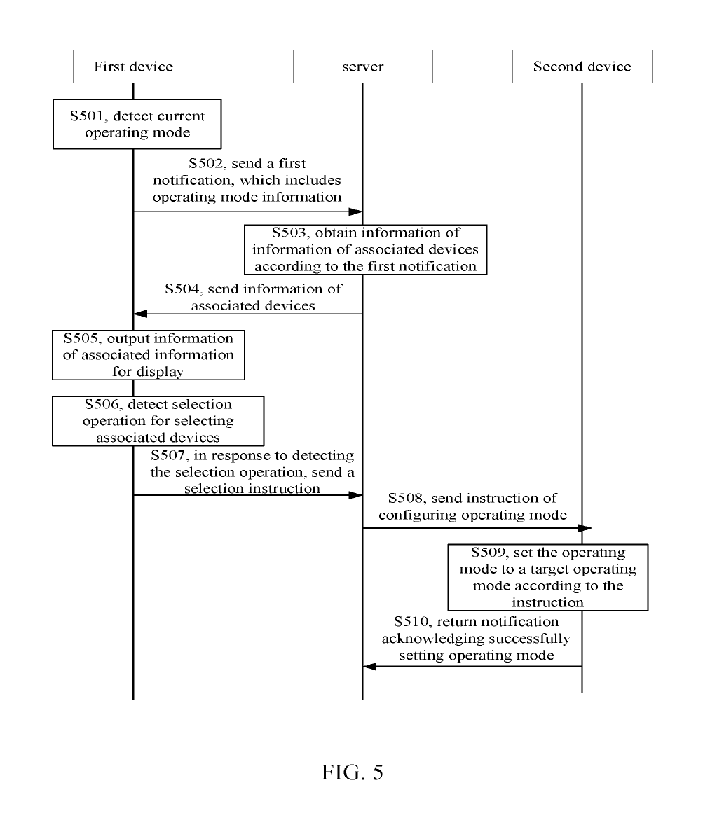

FIG. 4 is a flow chart of an example method for setting operating mode of a device according to an embodiment of the disclosure. In some embodiments, the method as illustrated in FIG. 4 is performed by a device similar to the first device described in conjunction with FIGS. 1-3. As shown in FIG. 4, the method for setting an operating mode of a device includes the following steps.

In step S401, a current operating mode is detected.

The first device detects its current operating mode. The first device may be a smart phone, a tablet, or the like. In an example when the first device is a smart phone, the operating mode of the phone includes a silent mode, a vibration mode, a sound mode, etc. In the silent mode, if the phone receives a call or a message, the phone will not notify the user in an audible manner, and the user thus cannot hear the ringtone for the incoming call or message.

In step S402, a first notification is sent to the server, wherein the first notification includes information regarding the detected current operating mode of the first device.

After detecting the current operating mode, the first device sends a first notification to the server to report the detected current operating mode to the server.

In step S403, the association information regarding one or more associated devices from a server obtained according to the first notification is received. The association information includes the information with respect to one or more devices associated with the first device.

After receiving the first notification sent by the first device, the server acquires the association information with respect to one or more devices associated with the first device according to the first notification. The server then sends the association information to the first device, wherein the association information may include information of the devices which are associated with the first device and that the operating modes thereof do not match the operating mode of the first device. After receiving the association information, the first device may display the association information as a list on a display of the first device, and the user may select the devices that will be set to corresponding target operating modes. In an alternative embodiment, the first notification includes the user identification, which is used by the server to determine the devices associated with the first device. The user may choose which devices to be associated with the user identification, and store the association between the devices and the user identification in the server. The user identification may correspond to a plurality of devices. The user identification may be the account used when the smart device used for authentication when executing the Xiaomi smart home application program. A user generally uses the same account to access the server for all the smart devices at home. In some embodiments, the user identification may also be other types of identifiers. After receiving the first notification, the server determines which devices are associated with the first device according to the user identification.

In step S404, a selection operation is performed for selecting one or more associated devices.

After the first device outputting the association information for display, the user selects one or more associated devices that will be subject to configuring the operating modes thereof from the displayed associated devices. The first device will detect the user selection of the associated devices.

In step S405, in response to detecting the selection operation, a selection instruction is sent to the server. The selection instruction indicates that one or more selected devices, including for example a second device, among the one or more devices that are associated with the first device are selected.

After detecting the selection operation by the user, the first device sends a selection instruction to the server. After receiving the selection instruction, the server controls the selected one or more devices to set the respective operating modes to corresponding target operating modes.

In an alternative embodiment, after detecting that the current operating mode is silent mode, if the first device includes a speaker, the first device may also notify the user in an audible manner that the first device activates a silent mode such that the user may be informed the operating mode of the first device promptly.

For example, after detecting the current operating mode is a silent mode, a cell phone sends a first notification to a server, wherein the first notification carries the information regarding the current operating mode of the cell phone. The cell phone receives the association information with respect to associated devices returned by the server according to the first notification, wherein the association information includes the information of the devices associated with the cell phone, such as smart sockets, smart air purifiers, smart light bulbs, smart refrigerators, or the like. The cell phone outputs the association information for display, and the user selects the devices that are subject to further operating mode configuration. The cell phone detects the selection operation performed by the user, and sends a selection instruction to the server, wherein the selection instruction is used to instruct the server to control the one or more selected devices indicated in the selection instruction to set the respective operating modes to corresponding silent modes.

In the method for setting an operating mode of a device in at least one embodiment, the first device detects the current operating mode, and sends a first notification to a server, wherein the first notification includes the detected operating mode information; output the association information with respect to associated device acquired according to the first notification and sent by the server for display, wherein the association information includes the information of one or more other devices associated with the device; detect a selecting operation for selecting one or more of the associated devices; and in response to the selecting operation, send a selection instruction to the server, wherein the selection instruction is used to instruct the server to control the one or more selected devices indicated in the selection instruction to set the respective operating modes to the respective target operating modes. In some embodiments, the user only needs to set the operating mode of the device, and the device reports the operating mode to a server, which automatically controls one or more other devices associated with the device to set the respective operating modes to the corresponding target operating modes. In accordance with some embodiments of the present disclosure, a user may conveniently set operating modes of various associated devices.

FIG. 5 is a flow chart of an example method for setting an operating mode of a device according to an embodiment of the disclosure. As shown in FIG. 5, the method for setting an operating mode of a device includes the following steps.

In step S501, the first device detects a current operating mode of the first device.

In step S502, the first device sends a first notification to a server, wherein the first notification includes the operating mode information.

In step S503, the server acquires the association information with respect to associated devices according to the first notification.

The association information may include: information of the devices which are associated with the first device and that the operating modes thereof do not match the operating mode of the first device.

In step S504, the server sends the association information to the first device.

In step S505, the first device outputs the association information for display.

In step S506, the first device detects the selection operation with respect to selecting one or more associated devices according to the association information.

In step S507, the first device sends a selection instruction to the server in response to the selection operation.

The selection instruction is used to instruct the server to control one or more selected devices, including a second device, to set the respective operating modes to corresponding target operating mode.

In step S508, the server sends an instruction of setting the operating mode to the second device.

The instruction of setting the operating mode includes the target operating mode.

In step S509, the second device set its operating mode to the target operating mode according to the instruction of setting the operating mode.

In step S510, the second device returns a notification acknowledging successfully setting up the operating mode to the server.

After setting the operating mode of the second device to the target operating mode, the second device returns a notification to the server acknowledging that the target operating mode has been adopted.

For example, after setting the operating mode of a cell phone to a silent mode, the server sets the operating modes of various smart devices associated with the cell phone, such as smart sockets, air purifiers, light bulbs, refrigerators, etc., to the corresponding silent modes. After setting the operating modes of the smart devices to the corresponding silent modes as instructed by the server, the smart devices return notifications to the server acknowledging setting the operating modes successfully. After receiving the notifications, the server determines that all the smart devices have already switched to their corresponding silent modes.

In some embodiments, the user only needs to set the operating mode of the first device, and reports the operating mode to the server. The server can automatically control one or more devices associated with the first device to set the respective operating modes to corresponding target operating modes according to the operating mode of the first device. In accordance with some embodiments of the present disclosure, a user may conveniently set operating modes of various associated devices.

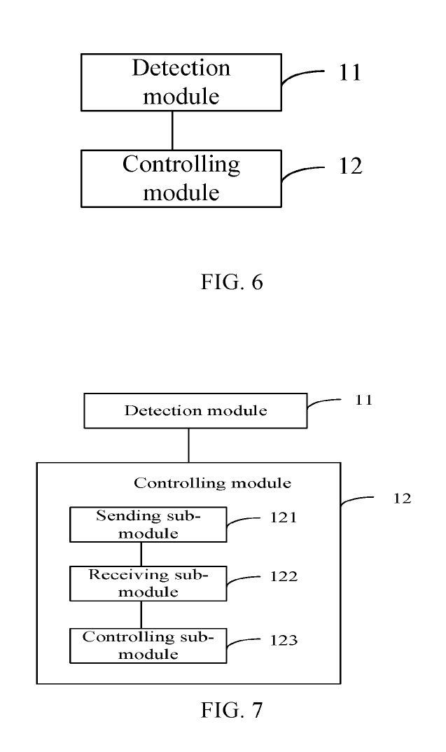

FIG. 6 is a block diagram of an example apparatus for setting an operating mode of a device according to an embodiment of the disclosure. As shown in FIG. 6, the apparatus for setting an operating mode includes a detection module 11 and a controlling module 12.

The detection module 11 is configured to detect the operating mode of a first device.

The controlling module 12 is configured to control a second device associated with the first device to set the operating mode of the second device to a target operating mode of the second device. The target operating mode matches the operating mode of the first device detected by the detection module 11.

In some embodiments, the target operating mode and the operating mode of the first device are consistent operating modes corresponding to consistent user experiences.

FIG. 7 is a block diagram for an example apparatus for setting an operating mode of a device according to an embodiment of the disclosure. On the basis of the apparatus for setting an operating mode of a device as shown in FIG. 6, the controlling module 12 in FIG. 7 further includes a sending sub-module 121, a receiving sub-module 122, and a controlling sub-module 123.

The sending sub-module 121 is configured to send association information with respect to the associated device to the first device. The association information may include the information of the devices associated with the first device.

The receiving sub-module 122 is configured to receive a selection instruction from the first device.

The controlling sub-module 123 is configured to control a second device indicated in the selection instruction to set the operating mode of the second device to the target operating mode.

In an alternative embodiment, the association information includes information of devices which are associated with the first device and the operating modes thereof do not match the operating mode of the first device.

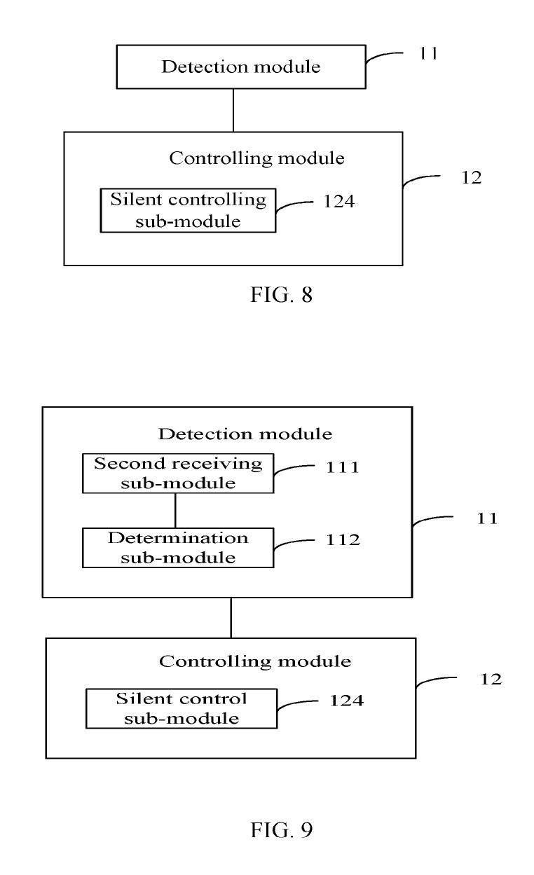

FIG. 8 is a block diagram for an example apparatus for setting an operating mode of a device according to an embodiment of the disclosure. On the basis of the apparatus for setting an operating mode of a device as shown in FIG. 6, the controlling module 12 in FIG. 8 further includes a silent controlling sub-module 124.

The silent controlling sub-module 124 is configured to control the second device to set the operating mode of the second device to a silent mode in response to detecting that the first device is in a silent mode by the detection module.

FIG. 9 is a block diagram for an example apparatus for setting an operating mode of a device according to an embodiment of the disclosure. On the basis of the apparatus for setting operating mode of a device as shown in FIG. 8, the detection module 11 in FIG. 9 further includes a second receiving sub-module 111 and a determining sub-module 112.

The second receiving sub-module 111 is configured to receive the notification indicating from a first device indicating that the first device is in a silent mode.

The determining sub-module 112 is configured to determine that the first device is in the silent mode in response to the notification received by the second receiving sub-module 111.

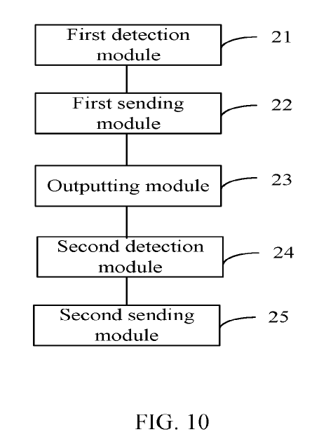

FIG. 10 is a block diagram for an example apparatus for setting an operating mode of a device according to an embodiment of the disclosure. The apparatus for setting an operating mode of a device as depicted in FIG. 10 may be used in a first device described above. As shown in FIG. 10, the apparatus for setting an operating mode of a device includes a first detection module 21, a first sending module 22, outputting module 23, a second detection module 24, and a second sending module 25.

The first detection module 21 is configured to detect a current operating mode.

The first sending module 22 is configured to send a first notification to a server, wherein the first notification includes the operating mode information.

The outputting module 23 is configured to output the association information with respect to one or more associated devices from the server for display. The association information includes the information with respect to the devices associated with the first device.

The second detection module 24 is configured to detect a selecting operation for selecting one or more associated devices.

The second sending module 25 is configured to send a selection instruction to the server in response to the selecting operation detected by the second detection module 24. The selection instruction may be used to instruct the server to control one or more selected devices indicated in the selection instruction to set the respective operating mode to corresponding target operating mode.

In an alternative embodiment, the association information may include information of devices which are associated with the first device and the operating modes thereof do not match the operating mode of the first device.

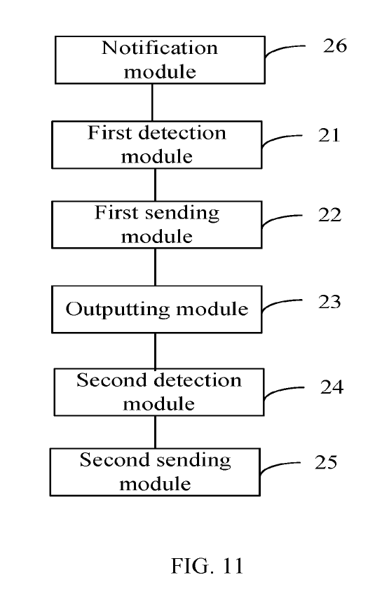

FIG. 11 is a block diagram for an example apparatus for setting an operating mode of a device according to an embodiment of the disclosure. On the basis of the apparatus for setting operating mode of a device as shown in FIG. 10, the apparatus for setting an operating mode of a device in FIG. 11 may further includes a notifying module 26.

The notifying module 26 is configured to notify the user in an audible manner that the first device has activated the silent mode after detecting that the current operating mode is the silent mode by the first detection module 21.

With respect to the apparatuses in the above embodiments, the specific manners that the respective modules perform operations have been described in detail in the embodiments regarding the relevant methods, and detailed description thereof is thus omitted.

It is noted that any one of the modules or sub-modules described in this disclosure can be implemented as hardware, software, or a combination of hardware and software. In an example, some or all of the modules or sub-modules in the FIGS. 6-11 are implemented as processing circuitry executing software instructions.

FIG. 12 is a block diagram of an example apparatus for setting an operating mode of a device according to an embodiment of the disclosure. The apparatus for setting an operating mode of a device as depicted in FIG. 10 may be used as a server described above. As shown in FIG. 12, the apparatus 300 for setting an operating mode of a device includes a processor 31 and a memory 32, where the memory 32 is used to store the processor-executable instructions and is communicatively coupled to the processor 31 via a system bus.

In some embodiments, the processor is configured to detect an operating mode of a first device and control a second device associated with the first device to set the operating mode of the second device to a target operating mode. In some embodiments, the target operating mode matches the operating mode of the first device.

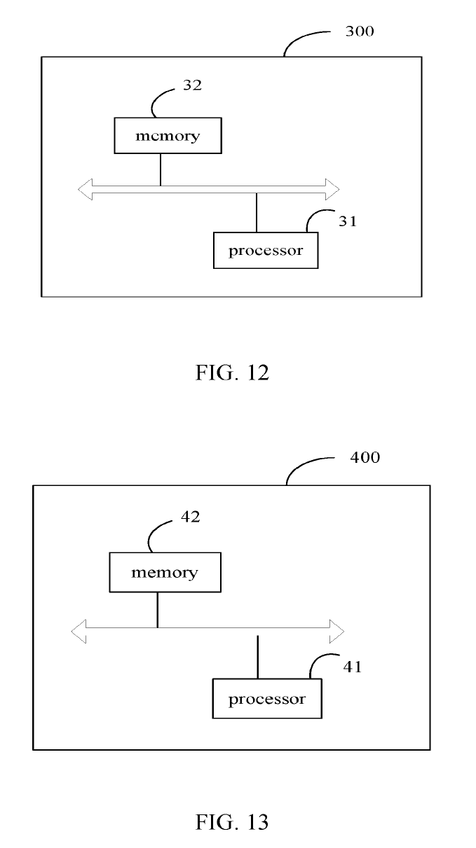

FIG. 13 is a block diagram of an example apparatus for setting an operating mode of a device according to an embodiment of the disclosure. The apparatus for setting an operating mode of a device as depicted in FIG. 11 may be used as a first device described above. As shown in FIG. 13, the apparatus 400 for setting an operating mode of a device includes a processor 41 and a memory 42, where the memory 32 is used to store the processor-executable instructions and is communicatively coupled to the processor 41 via a system bus.

In some embodiments, the processor is configured to detect a current operating mode, send a first notification to a server including the operating mode information, output association information from the server for display, detect a selection operation for selecting one or more associated devices according to the association information, and in response to detecting the selection operation, send an selection instruction to the server. The selection instruction is used to instruct the server to control one or more selected devices indicated in the selection instruction to set the respective operating modes to corresponding target operating modes.

In the above embodiments of entities of apparatuses for setting an operating mode of a device, it should be appreciated that the processor may be a Central Processing Unit (simplified as CPU), or other general-purpose processors, a Digital Signal Processor (simplified as DSP), an Application Specific Integrated Circuit (simplified as ASIC), or the like. The general-purpose processor may be microprocessor or other common processor, etc. The memory described above may be read-only memory (simplified as ROM), random access memory (simplified as RAM), flash memory, hard disk, or solid-state disk. The steps of method disclosed in conjunction with the embodiments of the disclosure may be performed by hardware processors, or be performed by the combination of the hardware and software module in the processor.

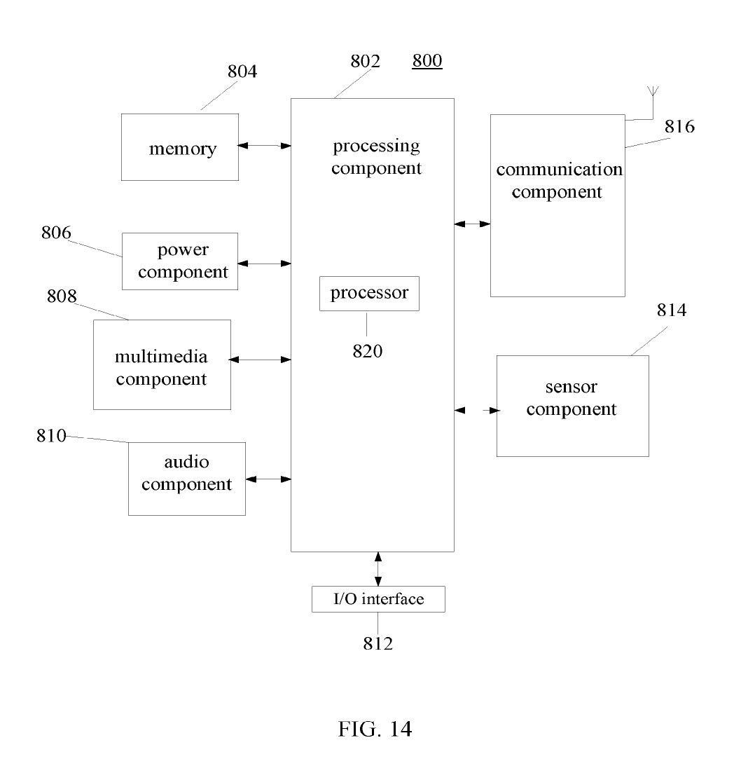

FIG. 14 is a block diagram of an example first device according to an embodiment of the disclosure. For example, the device 800 may be a mobile phone, a computer, a digital broadcast terminal, a messaging device, a gaming console, a tablet, a medical device, an exercise equipment, a personal digital assistant, and the like.

Referring to FIG. 14, the device 800 may include one or more of the following components: a processing component 802, a memory 804, a power component 806, a multimedia component 808, an audio component 810, an input/output (I/O) interface 812, a sensor component 814, and a communication component 816. It is noted that any one of the components described in this disclosure can be implemented as hardware, software, or a combination of hardware and software.

The processing component 802 typically controls overall operations of the device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power for the device 800.

The multimedia component 808 includes a display device providing an output interface between the device 800 and the user. In some embodiments, the display device may include a liquid crystal display (LCD) and a touch panel (TP). If the screen includes the touch panel, the display device may be implemented as a touch screen display to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the device 800 is in an operation mode, such as a photographing mode or a video mode. Each of the front camera and the rear camera may be a fixed optical lens system or have optical focusing and zooming capability.

The audio component 810 is configured to output and/or input audio signals. For example, the audio component 810 includes a microphone (“MIC”) configured to receive an external audio signal when the device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, the peripheral interface modules being, for example, a keyboard, a click wheel, buttons, and the like. The buttons may include, but are not limited to, a home button, a volume button, a starting button, and a locking button.

The sensor component 814 includes one or more sensors to provide status assessments of various aspects of the device 800. For instance, the sensor component 814 may detect an open/closed status of the device 800, relative positioning of components (e.g., the display and the keypad, of the device 800), a switch in position of the device 800 or a component of the device 800, a presence or absence of user contact with the device 800, an orientation or an acceleration/deceleration of the device 800, and a switch in temperature of the device 800. The sensor component 814 may include a proximity sensor configured to detect the presence of a nearby object without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the device 800 and other devices. The device 800 can access a wireless network based on a communication standard, such as WiFi, 2G, or 3G, or a combination thereof. In an exemplary embodiment, the communication component 816 receives a broadcast signal or broadcast associated information from an external broadcast management system via a broadcast channel. In an exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the device 800, for performing the above-described methods. For example, the non-transitory computer-readable storage medium may be a ROM, a RANI, a CD-ROM, a magnetic tape, a floppy disc, an optical data storage device, and the like.

In some embodiments, the non-transitory computer readable storage medium has stored thereon instructions that, when executed by a processor of a mobile terminal, cause the mobile terminal to perform a method for setting an operating mode of a device. In some embodiments, the method for setting an operating mode of a device including: detecting a current operating mode; sending a first notification to a server, wherein the first notification includes the operating mode information; outputting association information with respect to associated devices from the server for display; detecting a selection operation for selecting one or more associated devices based on the association information; and in response to detecting the selection operation, sending a selection instruction to the server, wherein the selection instruction is used to instruct the server to control one or more selected devices indicated in the selection instruction of selection to set the respective operating modes to corresponding target operating modes.

In some embodiments, the association information includes information of devices which are associated with the first device and the operating modes thereof do not match the operating mode of the first device.

In some embodiments, the method for setting an operating mode of a device further includes after detecting that the current operating mode is a silent mode, notifying the user in an audible manner that the first device has activated the silent mode.

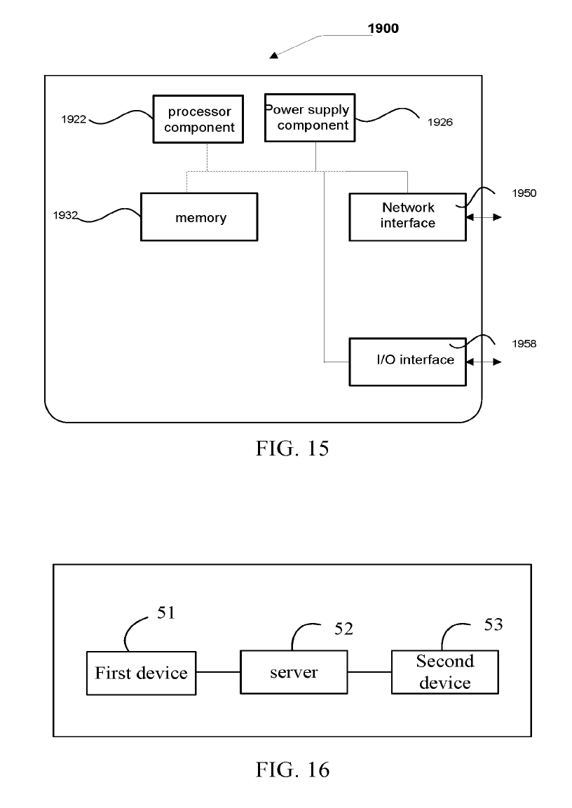

FIG. 15 is a block diagram of an example server according to an embodiment of the disclosure. For example, the device 1900 may be usable as a server described above. Referring to FIG. 15, the server 1900 may include: a processing component 1922, which further includes one or more processors; and memory resources presented by a memory 1932, which is used to store instructions (e.g. application programs) executable by the processor component 1922. The application programs stored in the memory 1932 may include one or more modules (not shown) corresponding to a set of instructions. Further, the processing component 1922 may be configured to execute the instructions to perform the methods of setting an operating mode of a device as shown in FIGS. 1-3.

The device 1900 may also include: a power supply 1926, used to provides power to server 1900; a wired or wireless network interfaces 1950, configured to enable the server 1900 connected to the network, an input/output interfaces 1958, and/or an operating systems 1941, such as Windows Server™, Mac OS X™, Unix™, Linux™, FreeBSD™, or the like.

FIG. 16 is a block diagram for an example system for setting an operating mode of a device according to an embodiment of the disclosure. As shown in FIG. 16, the system for setting an operating mode of a device includes: a first device 51, a server 52 and at least a second device 53.

The first device 51 is configured to: detect the current operating mode; sending a first notification to the server 52, wherein the first notification includes the operating mode information; output association information from the server 52 for display, wherein the association information includes the information regarding one or more devices associated with the first device; detect a selection operation for selecting one or more associated devices based on the association information; and, in response to detecting the selecting operation, send an selection instruction to the server 52, wherein the selection instruction is used to instruct the server to control one or more selected devices, including a second device 53, indicated in the instruction of selection to switch the respective operating modes to corresponding target operating modes.

The server 52 is configured to: detect an operating mode of a first device, and control the second device 53 associated with the first device 51 to set an operating mode of the second device to a target operating mode, where the target operating mode matches the operating mode of the first device.

Other embodiments of the disclosure will be apparent to those skilled in the art from consideration of the specification and practice of the disclosures herein. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated in the following claims.

It will be appreciated that the disclosure is not limited to the exact structure as described above and illustrated in the accompanying drawings, and that various modifications and variations can be made without departing from the scope thereof. It is intended that the scope of the disclosure is limited only by the appended claims.

What is claimed is:

1. A method, comprising:
detecting an operating mode of a first device; and
causing a second device associated with the first device to set an operating mode of the second device to a target operating mode, wherein the target operating mode matches the detected operating mode of the first device.

2. The method of claim 1, wherein causing the second device to set the operating mode of the second device to the target operating mode comprises:
sending association information to the first device, wherein the association information comprises information regarding one or more devices, including the second device, that are associated with the first device;
receiving a selection instruction from the first device, the selection instruction indicating that one or more selected devices, including the second device, among the one or more devices that are associated with the first device are selected; and
causing each device of the one or more selected devices indicated in the selection instruction, including the second device, to set an operating mode thereof to a corresponding target operating mode.

3. The method of claim 2, wherein the association information includes information of the one or more devices that are associated with the first device and that the operating modes thereof do not match the detected operating mode of the first device.

4. The method of claim 1, wherein causing the second device associated with the first device to set the operating mode of the second device to the target operating mode comprises:
in response to a result that the detected operating mode of the first device is a silent mode of the first device, causing the second device to set the operating mode of the second device to a silent mode of the second device.

5. The method of claim 4, wherein detecting the operating mode of the first device comprises:
receiving a notification from the first device indicating that the operating mode of the first device is the silent mode of the first device; and
in response to the received notification from the first device, determining that the detected operating mode of the first device is the silent mode of the first device.

6. The method of claim 1, wherein the target operating mode for the second device is consistent with the detected operating mode of the first device.

7. The method of claim 1, wherein the detecting the operating mode of the first device comprises:
sending a request to the first device based on a predetermined polling period, the request corresponding to causing the first device to report a current operating mode of the first device.

8. An apparatus, comprising:
a processor; and
a memory configured to store processor-executable instructions;
wherein the processor, when executing the processor-executable instructions, is configured to
detect an operating mode of a first device, and
cause a second device associated with the first device to set an operating mode of the second device to a target operating mode, wherein the target operating mode matches the detected operating mode of the first device.

9. The apparatus of claim 8, wherein the processor, when executing the processor-executable instructions, is configured to
send association information to the first device, wherein the association information comprises information regarding one or more devices, including the second device, that are associated with the first device,
receive a selection instruction from the first device, the selection instruction indicating that one or more selected devices, including the second device, among the one or more devices that are associated with the first device are selected, and
causing each device of the one or more selected devices indicated in the selection instruction, including the second device, to set an operating mode thereof to a corresponding target operating mode.

10. The apparatus of claim 9, wherein the association information includes information of the one or more devices that are associated with the first device and that the operating modes thereof do not match the detected operating mode of the first device.

11. The apparatus of claim 8, wherein the processor, when causing the second device associated with the first device to set the operating mode of the second device to the target operating mode, is configured to
in response to a result that the detected operating mode of the first device is a silent mode of the first device, cause the second device to set the operating mode of the second device to a silent mode of the second device.

12. The apparatus of claim 11, wherein, when detecting the operating mode of the first device, the processor is configured to
receive a notification from the first device indicating that the operating mode of the first device is the silent mode of the first device, and
in response to the received notification from the first device, determine that the detected operating mode of the first device is the silent mode of the first device.

13. The apparatus of claim 8, wherein the target operating mode for the second device is consistent with the detected operating mode of the first device.

14. The apparatus of claim 8, wherein, when detecting the operating mode of the first device, the processor is configured to
sending a request to the first device based on a predetermined polling period, the request corresponding to causing the first device to report a current operating mode of the first device.

15. A system, comprising:
a first device;
a second device; and
a server, the server is configured to
detect an operating mode of the first device, and
cause the second device associated with the first device to set an operating mode of the second device to a target operating mode, wherein the target operating mode matches the detected operating mode of the first device.

16. The system of claim 15, wherein
the first device is configured to
detect a current operating mode of the first device,
send a notification to the server, wherein the notification indicates the current operating mode of the first device,
output association information received from the server and acquired according to the notification for display, wherein the association information comprises the information regarding one or more devices, including the second device, that are associated with the first device,
detect a selection operation for selecting one or more associated devices according to the association information, and
send a selection instruction to the server, wherein the selection instruction is used to instruct the server to control one or more selected devices indicated in the selection instruction to set respective operating modes to corresponding target operating modes.

17. The system of claim 16, wherein
the server is configured to
send the association information to the first device in response to the received notification from the first device,
receive the selection instruction from the first device, and
cause each device of the one or more selected devices indicated in the selection instruction, including the second device, to set an operating mode thereof to a corresponding target mode.

18. The system of claim 16, wherein the first device is configured to generate the selection instruction based on a user operation.

19. The apparatus of claim 15, wherein the server, when detecting the operating mode of the first device, is configured to
send a request to the first device based on a predetermined polling period, the request corresponding to causing the first device to report a current operating mode of the first device.

20. The apparatus of claim 15, wherein the first device is configured to
detect a change of operating mode of the first device, and
send a notification to the server, wherein the notification indicates a current operating mode of the first device after the change of the operating mode of the first device.
